(19) United States
(12) Patent Application Publication
(10) Pub. No.: US 2025/0075711 A1
(43) Pub. Date: Mar. 6, 2025

(54) MODULATOR FOR GENERATING A PRESSURE CHANGE, PNEUMATIC VEHICLE SYSTEM, COMMERCIAL VEHICLE, AND METHOD FOR CONTROLLING A PNEUMATIC PRESSURE IN A PNEUMATIC LOAD BY OPEN-LOOP OR CLOSED-LOOP CONTROL

(71) Applicant: ZF CV Systems Global GmbH, Bern (CH)

(72) Inventor: Alexander Waßmann, Suthfeld (DE)

(21) Appl. No.: 18/819,009

(22) Filed: Aug. 29, 2024

(30) Foreign Application Priority Data
Sep. 1, 2023 (DE) 10 2023 123 598.2

(51) Int. Cl. F15B 13/04; B60T 13/26; B60T 13/68

(52) U.S. Cl. CPC F15B 13/0401; B60T 13/268; B60T 13/683; F15B 2211/528

(57) ABSTRACT

A modulator (20) for generating a pressure change in response to a control pressure has a first venting path (25) and a second venting path (26) for venting a pneumatic load (11). The modulator (20) has a relay valve (30) that is configured to vent the pneumatic load (11) via the first venting path (25). The modulator (20) has a vent valve (40) that is configured to vent the pneumatic load (11) via the second venting path (26).

### FIELD

The present disclosure relates to a modulator for generating a pressure change, and to a method for controlling a pneumatic pressure in a pneumatic load by open-loop or closed-loop control. The present disclosure relates in particular to such devices and methods by way of which a pneumatic load may be selectively supplied with pressure from a pressurized-gas source or vented. The present disclosure relates to such modulators and methods that can be used in the automotive sector, as well as to a pneumatic vehicle system and a commercial vehicle that has such a modulator.

### BACKGROUND

Modulators are used to produce pressure changes in a working circuit in dependence on a pressure change in a control circuit. Examples of fields of application include motor vehicles, for example braking systems or other pneumatic vehicle systems of commercial vehicles or other motor vehicles. DE 10 2006 041 008 A1 discloses a pneumatic vehicle braking system that has a modulator.

Due to regulatory requirements or other safety-related requirements, it may be necessary for a reduction in a control pressure to cause a prompt change (e.g. realized within a target time) in a pressure in the working circuit. An example of this is the drop in a brake pressure applied to a cylinder in response to a drop in a control pressure. Due to construction geometries and space requirements of modulators, this is sometimes difficult to achieve.

### SUMMARY

It is an object of the present disclosure to specify an improved modulator and an improved method designed so that a reduction in a control pressure causes a rapid change in pressure in the working circuit. It is in particular an object of the present disclosure to specify such a modulator and such a method by which a venting rate of a load may be increased when an output pressure at a pressurized-gas output decreases too slowly in comparison with a control pressure.

The object is achieved according to the present disclosure by a modulator for generating a pressure change, by a pneumatic vehicle system, by a commercial vehicle and by a method for controlling a pneumatic pressure in a pneumatic load by open-loop or closed-loop control, as described in the present disclosure. Additional aspects of the present disclosure provide advantageous or preferred exemplary embodiments.

A modulator, according to the present disclosure, for generating a pressure change has a control-pressure input for receiving a control pressure, a pressurized-gas input and at least one pressurized-gas output. The modulator has a first venting path and a second venting path for venting a pneumatic load. At least part of the first venting path is different from at least part of the second venting path. The modulator has a relay valve that is pneumatically controllable by the control pressure and has at least a first valve position and a second valve position, the relay valve being configured to provide, in the first valve position, a fluidic connection between the pressurized-gas input and the at least one pressurized-gas output and to provide, in the second valve position, a fluidic connection between the at least one pressurized-gas output and the first venting path for the purpose of venting the pneumatic load. The modulator has a vent valve that is pneumatically controllable by the control pressure and that is configured to selectively provide, in dependence on the control pressure, a fluidic connection between the at least one pressurized-gas output and the second venting path for the purpose of venting the pneumatic load.

The modulator provides various technical effects and advantages. The second venting path and the vent valve provided in addition to the relay valve enable the pneumatic load to be vented in parallel via the first venting path and the second venting path. The second venting path also may be used selectively for venting when a pressure at the pressurized-gas output would drop too slowly in comparison with the control pressure if the pneumatic load were vented only via the first venting path. Venting may thus be effected more rapidly, with the vent valve and the second venting path selectively involved in the venting process, for example in certain operating situations.

Specified according to a further aspect of the present disclosure is a method for controlling a pneumatic pressure in a pneumatic load by open-loop or closed-loop control by use of a modulator. The modulator has a first venting path and a second venting path. At least part of the first venting path is different from at least part of the second venting path. The method comprises: supplying pressurized gas from a pressurized-gas source to the pneumatic load via the modulator, and venting the pneumatic load via the modulator. Venting the pneumatic load comprises: pneumatically actuating a relay valve of the modulator by way of a control pressure received by the modulator in order to vent the pneumatic load via the first venting path, and pneumatically actuating a vent valve by way of the control pressure in order to additionally vent the pneumatic load via the second venting path.

The method provides various technical effects and advantages. The second venting path and the vent valve provided in addition to the relay valve enable the pneumatic load to be vented in parallel via the first venting path and the second venting path. The second venting path also may be used selectively for venting when a pressure at the pressurized-gas output would drop too slowly in comparison with the control pressure if the pneumatic load were vented only via the first venting path. Venting may thus be effected more rapidly, with the vent valve and the second venting path selectively involved in the venting process, for example in certain operating situations.

The modulator and the method according to exemplary embodiments can be used in pneumatic vehicle systems of motor vehicles, in particular commercial vehicles. Pneumatic braking systems of commercial vehicles are a field of application in which the modulator and the method can be used in a particularly advantageous manner.

### BRIEF DESCRIPTION OF THE DRAWINGS

Further advantages, features and details of the present disclosure are disclosed by the following description of preferred embodiments. Embodiments of the present disclosure are described below with reference, in particular, to the figures. These do not necessarily represent the embodiments to scale. Rather, where expedient for explanation, the figures are in a schematic and/or slightly distorted form.

FIG. 1 shows a pneumatic vehicle system having a modulator, in an operating state in which a pneumatic load is vented.

FIG. 2 shows the pneumatic vehicle system from FIG. 1 when the pneumatic load is supplied with pressurized gas.

FIG. 3 shows a specific design of the pneumatic vehicle system from FIG. 1, in an operating state in which a pneumatic load is vented.

FIG. 4 shows a further embodiment of a pneumatic vehicle system having a modulator, in an operating state in which a pneumatic load is vented.

FIG. 5 shows yet a further embodiment of a pneumatic vehicle system having a modulator.

FIG. 6 shows a perspective view of a modulator that can be used with the pneumatic vehicle system.

FIG. 7 shows a sectional view of the modulator from FIG. 6.

FIG. 8 shows a detail view of the sectional view of the modulator from FIG. 6.

FIG. 9 shows a design of a vent valve that can be used with the modulator according to an embodiment.

FIG. 10 shows a detail view of features of the vent valve from FIG. 9.

FIG. 11 shows a further design of a vent valve that can be used with a modulator according to an embodiment.

FIG. 12 shows a further perspective view of the modulator that can be used with the pneumatic vehicle system.

FIG. 13 shows a pneumatic vehicle system.

FIG. 14 shows a commercial vehicle.

FIG. 15 shows a flow diagram of a method.

FIG. 16 shows pressure curves as a function of time, to explain the operation of the modulator.

### DETAILED DESCRIPTION

The modulator, the pneumatic vehicle system and the method according to embodiments of the present disclosure are preferably used in a commercial vehicle, without being limited thereto.

Described in detail below, in particular, are embodiments of a modulator for generating a pressure change. The modulator has a control-pressure input for receiving a control pressure, a pressurized-gas input and at least one pressurized-gas output. The modulator has a first venting path and a second venting path for venting a pneumatic load. At least part of the first venting path is different from at least part of the second venting path. The modulator has a relay valve that is pneumatically controllable by the control pressure and has at least a first valve position and a second valve position, the relay valve being configured to provide, in the first valve position, a fluidic connection between the pressurized-gas input and the at least one pressurized-gas output and to provide, in the second valve position, a fluidic connection between the at least one pressurized-gas output and the first venting path for the purpose of venting the pneumatic load. The modulator has a vent valve that is pneumatically controllable by the control pressure and that is configured to selectively provide, in dependence on the control pressure, a fluidic connection between the at least one pressurized-gas output and the second venting path for the purpose of venting the pneumatic load.

As already explained above, various technical effects and advantages are achieved due to the modulator.

The relay valve and the vent valve may be configured to vent the pneumatic load in parallel via the first venting path and the second venting path.

Parallel venting can prevent the pressure at the pressurized-gas output from following a drop in the control pressure with an unacceptable delay. The second venting path may be activated selectively when this is appropriate because of a time characteristic of the control pressure and of the pressure at the pressurized-gas output.

The vent valve may be configured to provide the fluidic connection between the at least one pressurized-gas output and the second venting path upon a decrease in the control pressure.

More rapid venting can thereby be achieved.

The vent valve may be configured to provide the fluidic connection between the at least one pressurized-gas output and the second venting path in dependence on a rate at which the control pressure decreases.

Parallel venting, via both the first venting path and the second venting path, can thus be provided selectively when this is rendered necessary by a rapid rate of decrease in the control pressure.

The vent valve may be configured to provide the fluidic connection between the at least one pressurized-gas output and the second venting path in dependence on a ratio between the control pressure and a pressure at the at least one pressurized-gas output.

Venting can thus always be effected selectively also via the second venting path when a decrease in the control pressure precedes too far in advance of a decrease in the pressure at the pressurized-gas output.

The vent valve may be configured to provide venting via the second venting path in dependence on a difference between the pressure at the pressurized-gas output and the control pressure.

Venting can thus always be effected selectively also via the second venting path when a difference between the pressure at the pressurized-gas output and the control pressure attains or exceeds a threshold value.

The vent valve may be configured to selectively provide the fluidic connection between the at least one pressurized-gas output and the second venting path when a difference between the pressure at the pressurized-gas output and the control pressure fulfils a threshold value criterion, for example is equal to or greater than a threshold value.

Venting can thus always be effected selectively also via the second venting path when the difference between the pressure at the pressurized-gas output and the control pressure fulfils the threshold value criterion.

The vent valve may have a diaphragm.

The vent valve can thus be realized in a technically simple, robust and easily configurable manner.

At least one region of the diaphragm may be arranged between a first fluid space and a second fluid space.

This enables the vent valve to be actuated by a pressure difference between the first fluid space and the second fluid space.

The modulator may have a control-pressure chamber that is fluidically connected to control-pressure input. The first fluid space may be fluidically connected the control-pressure chamber. The second fluid space may be fluidically connected to the at least one pressurized-gas output.

The vent valve can thus be actuated in dependence on a pressure difference or a quotient between the at least one pressurized-gas output and the control pressure.

The vent valve may also have a reversibly deformable energy storage element.

The diaphragm can thus be pressed into a wanted neutral position. The energy storage element allows the vent valve to be configured in such a way that it opens at a determined pressure differential between the pressure at the at least one pressurized-gas output and the control pressure, the pressure differential being dependent on the energy storage element and a geometry of the diaphragm.

The diaphragm may have a side on which both the reversibly deformable energy storage element and the first fluid space are arranged.

It can thereby be achieved that venting via the second venting path is effected only when, upon a decrease in the control pressure, the pressure at the at least one pressurized-gas output follows the control pressure so closely that the pressure in the second fluid space moves the diaphragm, against the forces exerted by the pressure in the first fluid space and by the energy storage element, from a neutral position in which the vent valve fluidically separates the second venting path from the at least one pressurized-gas output.

The vent valve may be configured for bearing of the diaphragm in a sealing manner against a valve seat under the action of the control pressure upon the diaphragm.

It is thereby ensured that the vent valve can establish the fluidic connection between the at least one pressurized-gas output and the second venting path only when the control pressure drops.

The vent valve may also have a support element that extends along part of the diaphragm.

The vent valve can thus be provided in a simple, compact and robust manner.

The diaphragm may have a peripheral edge and a sealing face that is spaced apart from the peripheral edge, the sealing face being configured for bearing in a sealing manner against a valve seat.

The vent valve can thus be provided in a simple, compact and robust manner.

The vent valve may be configured to provide the fluidic connection between the at least one pressurized-gas output and the second venting path if the ratio attains a threshold value that is dependent on a geometric design of the diaphragm.

It can thereby be achieved that venting via the second venting path is effected only when, upon a drop in the control pressure, the pressure at the at least one pressurized-gas output follows the control pressure so closely that the pressure in the second fluid space moves the diaphragm, against the force exerted by the pressure in the first fluid space, from its neutral position.

The vent valve and the relay valve may be configured such that, upon a drop in the control pressure, the vent valve provides the fluidic connection between the pressurized-gas output and the second venting path after the relay valve provides the fluidic connection between the pressurized-gas output and the first venting path.

Parallel venting, by both the first and the second venting path, can then be provided selectively when necessary in order that a time interval, between a falling slope of the control pressure and the corresponding falling slope of the pressure at the pressurized-gas output, is kept short.

The vent valve may be or have a 2/2-way valve or a 3/2-way valve or a 4/2-way valve. The vent valve may have a first vent-valve valve port that is fluidically connected or connectable to the at least one pressurized-gas output. The vent valve may have a second vent-valve valve port that is fluidically connected to the second venting path.

The function whereby an additional venting path for the at least one load is provided selectively by way of the modulator can thus be realized in a simple and reliable manner.

The vent valve may have a vent-valve control port that is fluidically connected or connectable to the control-pressure input.

Pneumatic operation of the vent valve in dependence on a pressure differential between the at least one pressurized-gas output and the control pressure can thus be realized in a simple and reliable manner.

The vent valve may have a further vent-valve control port that is fluidically connected or connectable to the pressurized-gas output.

Pneumatic operation of the vent valve in dependence on a pressure differential between the at least one pressurized-gas output and the control pressure can thus be realized in a simple and reliable manner.

The relay valve may be or have a 3/2-way valve or 4/2-way valve. The relay valve may have a first relay-valve valve port that is fluidically connected or connectable to the at least one pressurized-gas input. The relay valve may have a second relay-valve valve port that is fluidically connected or connectable to the at least one pressurized-gas output. The relay valve may have a third relay-valve valve port that is fluidically connected to the second venting path.

The function of supplying pressurized gas to the pneumatic load or of venting the pneumatic load can thus be realized.

The relay valve may have a relay-valve control port that is fluidically connected or connectable to the control-pressure input.

Pneumatic operation of the relay valve in dependence on the control pressure can thus be realized.

The control pressure may be a control pressure generated by a braking-value transmitter, or may be dependent on a control pressure generated by a braking-value transmitter.

The modulator can thus be used in an advantageous manner in a pneumatic braking system.

The modulator may have a first modulator unit, which comprises the relay valve and the vent valve and which is assigned to a first load or to a plurality of first loads. The modulator may also have a second modulator unit, which has a further relay valve and a further vent valve. The further relay valve may be configured to supply one or more second loads with pressurized gas in dependence on the control pressure. The further relay valve may be configured to vent the one or more second loads, via a further first venting path of the modulator, in dependence on the control pressure. The further vent valve may be configured to vent the one or more second loads via a further second venting path of the modulator.

The modulator may thus be used in combination with a plurality of pneumatic loads that are supplied with pressurized gas and vented via at least two different modulator units of the modulator. This may be desirable, for example, in the case of axle modulators.

The modulator may have at least one further pressurized-gas output, which is fluidically connected to the further vent valve and the further relay valve. The further vent valve may be fluidically connected to the pressurized-gas input. The further vent valve and the further relay valve may be fluidically connected to the vent opening or to a further vent opening that is different from the latter.

The one or more second loads can thus be supplied with pressurized gas and vented via the at least one further pressurized-gas output.

The further vent valve may be configured to be actuated in dependence on a pressure difference between a pressure at the at least one further pressurized-gas output and the control pressure. For this purpose, the further vent valve may be designed as a pneumatically actuated valve.

The one or more second loads can thus also be selectively vented via the further second venting path when a pressure at the at least one further pressurized-gas output would follow the control pressure too closely in time after a drop in the control pressure.

Optional further features of the further vent valve and of the further relay valve correspond to the features and their effects explained with reference to the vent valve and the relay valve.

The second modulator unit may be substantially identical in structural design to the first modulator unit and arranged with it in a common housing.

This makes it possible to use structurally identical components for the first and the second modulator unit. The maintenance and inventory costs can be reduced.

The second modulator unit may have a spatial design and arrangement of valves that is a mirror image of that of the first modulator unit.

This allows all pressurized-gas outputs to be arranged on the same side of the housing of the modulator.

The modulator may be designed such that each pressurized-gas output of the modulator is fluidically connected to only exactly one relay valve of the modulator and to only exactly one vent valve of the modulator.

This makes it possible to achieve simple assignment of loads to valves of the modulator.

The modulator may also have a housing. The modulator may also have a vent opening in the housing.

This facilitates venting of the at least one pneumatic load and, if present, of the at least one second pneumatic load, via the modulator, into the environment.

Both the first venting path and the second venting path may lead into the vent opening.

A particularly simple structural design is thus realized.

The relay valve, the vent valve and, if present, the second relay valve and the second vent valve may be arranged in the housing.

This facilitates mounting of the modulator as a structural unit.

The vent valve may be arranged, in the housing, in a region in the vicinity of the at least one pressurized-gas output.

It can thereby be ensured that a pressure applied to a diaphragm of the vent valve substantially corresponds to the pressure at the at least one pressurized-gas output.

A pneumatic vehicle system according to a further aspect of the present disclosure comprises: at least one pneumatic load, the modulator according to an embodiment, and at least one connection that fluidically connects the at least one pneumatic load to the modulator.

The technical effects explained with reference to the modulator are thus realized in the pneumatic vehicle system. In such a system, it may be particularly important for safety or further regulatory reasons that a drop in a control pressure results in a drop in a pressure in the working circuit, i.e. at the pneumatic load, and any time delay should be short.

The at least one pneumatic load may comprise one brake cylinder or a plurality of brake cylinders.

The technical effects explained with reference to the modulator are thus realized in a pneumatic braking system. In such a system, it may be particularly important for safety or further regulatory reasons that a drop in a control pressure results in a drop in a pressure in the working circuit, i.e. in the brake pressure, and any time delay should be short.

The pneumatic vehicle system may comprise an electronic braking system (EBS).

The technical effects explained with reference to the modulator are thus realized in a braking system that comprises an EBS.

A commercial vehicle according to a further aspect of the present disclosure comprises the modulator according to an embodiment of the present disclosure or the pneumatic vehicle system according to an embodiment of the present disclosure.

The technical effects explained with reference to the modulator are thus realized in a commercial vehicle. In such a system, it may be particularly important for safety or further regulatory reasons for time delays between a drop in pressure in a working circuit and a drop in pressure in the control circuit to be kept short.

Provided according to further embodiments is a method, which has already been explained. Optional features of the method and the effects achieved thereby correspond to the features and effects explained with reference to the modulator, the pneumatic vehicle system and the commercial vehicle. The method may be executed by use of a modulator, a pneumatic vehicle system or a commercial vehicle according to any of the disclosed embodiments.

In the following, features and effects are explained further with reference to the figures.

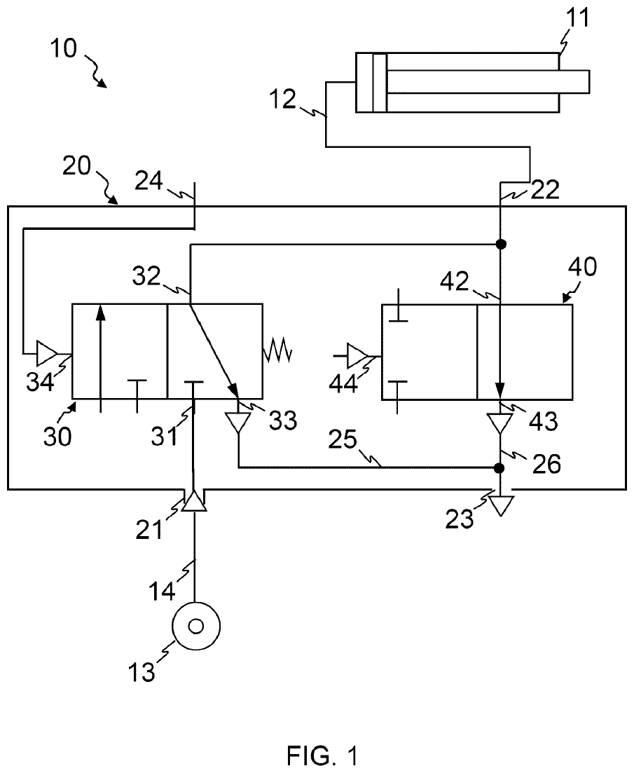

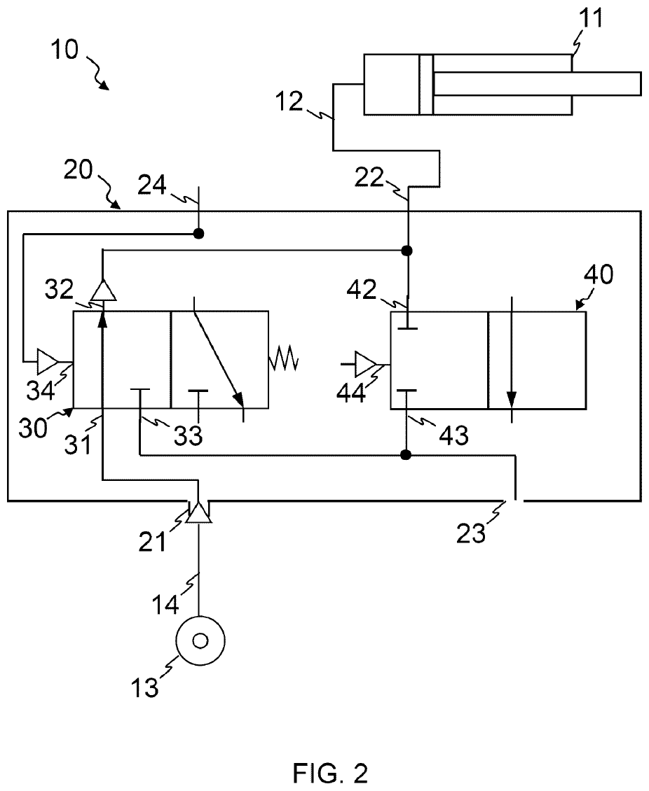

FIG. 1 and FIG. 2 are schematic representations of a pneumatic vehicle system 10. The pneumatic vehicle system 10 may be designed as a pneumatic braking system. The pneumatic vehicle system 10 may comprise an electronic braking system (EBS). FIG. 1 shows a state in which a modulator 20 is in a first operating state, in which a pneumatic load 11 is vented via the modulator 20. FIG. 2 shows another state, in which the modulator 20 is in a second operating state, in which a pneumatic load 11 is supplied with pressurized air.

The pneumatic system 10 comprises the pneumatic load 11, a pressurized-gas source 13 and the modulator 20. The pressurized-gas source 13 is fluidically connected to the modulator 20 via a pressurized-gas source connection 14. The pneumatic load 11 is fluidically connected to the modulator 20 via a load connection 12. The load connection 12 and/or the pressurized-gas source connection 14 may each be designed as connection lines or connection channels.

The modulator 20 is configured to supply the pneumatic load 11 with pressurized gas (as represented in FIG. 2) and to vent it via the modulator 20 (as represented in FIG. 1). The modulator 20 is configured for venting the pneumatic load 11 in such a way that the pneumatic load 11 may be vented in parallel both via a first venting path 25, via a relay valve 30, and via a second venting path 26, via a vent valve 40 that is different from the relay valve 30.

The modulator 20 has a pressurized-gas input 21 in order to receive pressurized gas or a pneumatic pressure from the pressurized-gas source 13. A pressurized-gas reservoir (not represented in FIG. 1) may be arranged between the pressurized-gas source 13 and the pressurized-gas input 21.

The modulator 20 has a pressurized-gas output 22, which is configured to be fluidically connected to the pneumatic load 11. Via the pressurized-gas output 22, pressurized gas is provided to the pneumatic load 11 by the modulator 20. The modulator 20 receives pressurized gas, at the pressurized-gas output 22, from the pneumatic load 11 when the latter is being vented. The modulator 20 has a vent opening 23. Gas or the pneumatic pressure received by the modulator 20 at the pressurized-gas output 22 from the pneumatic load 11 is discharged into an environment of the modulator 20 via the vent opening 23. The modulator 20 has a control-pressure input 24 in order to receive a control pressure. The control pressure may be a control pressure generated by a braking-value transmitter. The control pressure is used to set whether the modulator 20 supplies the pneumatic load 11 with pressurized gas or vents it.

The modulator 20 comprises the relay valve 30 and the vent valve 40. The relay valve 30 is designed as a pneumatically controllable valve. The relay valve 30 is configured to provide, in dependence on the control pressure at the control-pressure input 24, either a fluidic connection between the pressurized-gas input 21 and the pressurized-gas output 22 via the relay valve 30 (operating state of FIG. 2) or to provide a fluidic connection between the pressurized-gas output 22 and the vent 23 (operating state of FIG. 1).

The relay valve has a relay-valve control port 34 that is fluidically connected to the control-pressure input 24 of the modulator 20. The relay valve 30 has a first relay-valve valve-port 31, which is fluidically connected to the pressurized-gas input 21. The relay valve 30 has a second relay-valve valve port 32, which is fluidically connected to the pressurized-gas output 22. The relay valve 30 has a third relay-valve valve port 33, which is fluidically connected to the vent opening 23 via a first venting path 25.

The vent valve 40 is configured to fluidically connect the pressurized-gas output 22 to the vent opening 23 in dependence on a pressure at the pressurized-gas output 22 and the control pressure at the control-pressure input 24, optionally in dependence on a pressure differential or quotient between the pressure at the pressurized-gas output and the control pressure. In the case of this operating state represented in FIG. 1, venting is effected both via the first venting path 25 and via the second venting path 26. Such parallel venting, via both the first venting path 25 and the second venting path 26, may be effected selectively only when a drop in the pressure at the pressurized-gas output follows a drop in the control pressure in such a way that venting is also effected via the second venting path 26.

The vent valve 40 has a first vent-valve valve port 42, which is fluidically connected to the pressurized-gas output 22. The vent valve 40 has a second vent-valve valve port 43, which is fluidically connected to the vent opening 23 via the second venting path 26.

The vent valve 40 may be pneumatically controllable and may have at least one vent-valve control port 44.

In the case of the operating state represented in FIG. 2, in which the control pressure operates the relay valve 30 such that a supply of pressurized air to the pneumatic load 11 is effected, the vent valve 40 is closed.

Due to the selectivity of venting via the second venting path 26 in addition to venting via the first venting path 25, the modulator 20 may thus have a further operating state, in which venting is effected only via the first venting path 25, but no gas flow occurs between the second vent-valve valve port 43 and the vent opening 23 (i.e. the second venting path 26 is not activated).

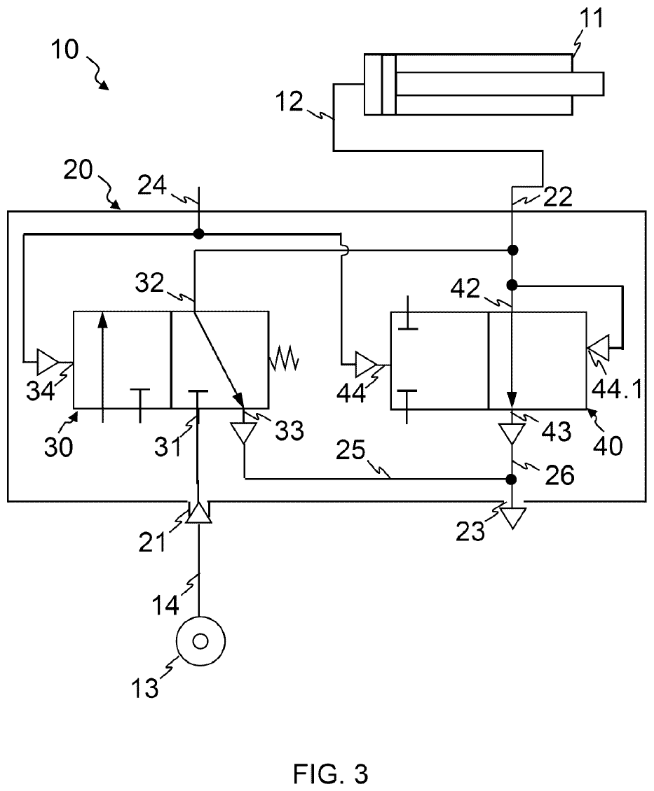

FIG. 3 shows a specific design of the modulator 20, the vent valve 40 being designed as a pneumatic controllable valve. The vent valve 40 may be designed, in particular, as a diaphragm valve. Operation of the vent valve 40 may be effected based on the control pressure and a pressure at the pressurized-gas output 22. For this purpose, the vent valve 40 may have a diaphragm, applied to the mutually opposite main faces of which are the control pressure and the pressure at the pressurized-gas output 22. Other designs are possible, the vent valve 40 being advantageously effected in dependence on a pressure differential between the pressure at the pressurized-gas output 22 and the control pressure, in which case the control pressure may be received at a vent-valve control port 44. The vent-valve control port 44 is fluidically connected to the control-pressure input 24.

In the case of the design represented in FIG. 3, venting via the second venting path 26 in parallel with venting via the first venting path 25 is selectively effected only when the pressure differential between the pressure at the pressurized-gas output 22 and the control pressure from the control-pressure input 24 attains or exceeds a threshold value. The threshold value may be configured by the valve geometry, in particular by the geometry of a diaphragm of the vent valve, and/or other valve components (such as, for example, an energy storage element and a support element, which will be described later) and adapted to the respective application of the modulator 20. For example, the vent valve 40 may be realized as a diaphragm valve or check valve having two control-pressure inputs 44, 44.1, a vent input or the first vent-valve valve port 42 and a vent output or the second vent-valve valve port 43.

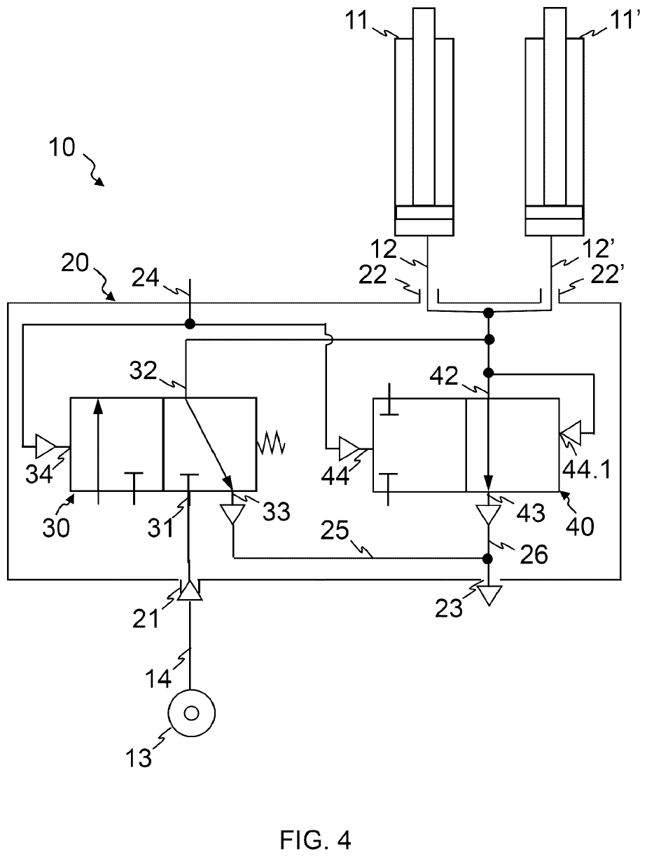

FIG. 4 shows a further specific design of the modulator 20, in which the modulator 20, in addition to having the pressurized-gas output 22, has a second pressurized-gas output 22′. The modulator 20 of FIG. 4 is configured such that both the pneumatic load 11 and a second pneumatic load 11′ may be supplied with the pneumatic pressure or pressurized gas and vented via the modulator 20.

The modulator 20 of FIG. 4 is configured such that both the pressurized-gas output 22 and the second pressurized-gas output 22′ are fluidically connected to the second relay-valve valve port 32. The modulator 20 of FIG. 4 is configured in such a way that both the pressurized-gas output 22 and the second pressurized-gas output 22′ are fluidically connected to the first vent-valve valve port 42. This makes it possible to vent both the pneumatic load 11 and the second pneumatic load 11′ both via the first venting path 25 and via the second venting path 26 if a pressure differential, between the pressure at the pressurized-gas outputs 22, 22′ and the control pressure, requires this and/or if an influencing variable of the pneumatic control pressure at the control pressure input 44 of the vent valve 40 is greater than an influencing variable of the pneumatic control pressure at the control-pressure input 44.1 and/or if a difference or a quotient of these pressures fulfils a threshold value criterion.

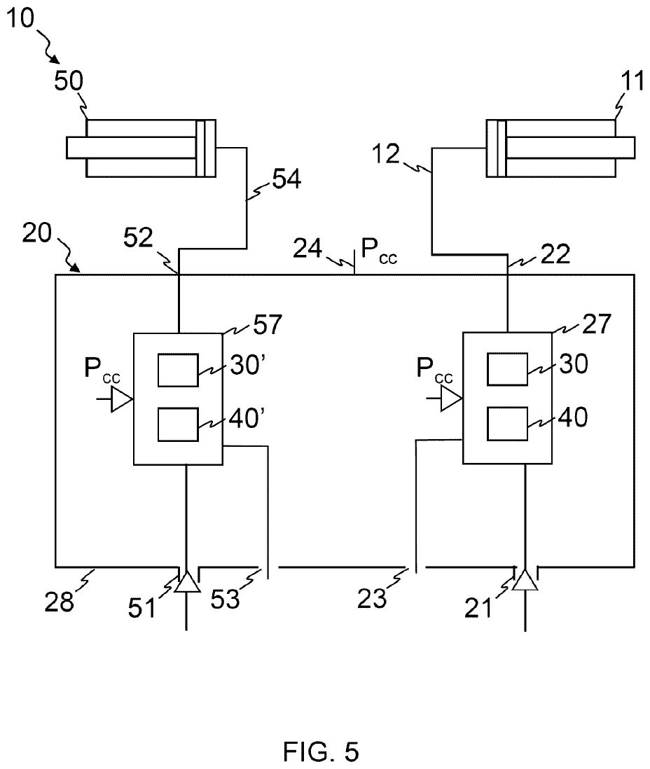

FIG. 5 shows a pneumatic system 10 with a further specific design of the modulator 20. The modulator 20 has a first modulator unit 27, which has a vent valve 40 and a relay valve 30. The first modulator unit 27 is configured to supply the pneumatic load 11 with pressurized air from a pressurized-air input 21 and to vent it via a vent opening 23. The function and design of the relay valve 30 and the vent valve 40 may be realized as described in detail with reference to FIG. 1 to FIG. 4.

The modulator 20 of FIG. 5 additionally has a second modulator unit 57. The second modulator unit 57 is configured to supply the pneumatic load 11 with pressurized air and to vent it. The second modulator unit 57 has a further relay valve 30′ and a further vent valve 40′. The further relay valve 30′ and the further vent valve 40′ may be configured in a manner identical to the relay valve 30 and vent valve 40 described above in respect of their design and function. The second modulator unit 57 is configured to supply the further pneumatic load 50, which is connected to a further pressurized-gas output 52 of the modulator 20 via a load connection 54, with pressurized gas and to vent it. The modulator 20 may accordingly have a further pressurized-gas input 51 for receiving pressurized gas from a pressurized-gas source. The modulator 20 may optionally have a further vent opening 53, which is fluidically connected to both the further relay valve 30′ and the further vent valve 40′. In this case, the further relay valve 30′—in a manner similar to the design described above—may be connected to the further vent opening 53 via a further first venting path, and the further vent valve 40′ may be connected to the further vent opening 53 via a further second venting path.

The modulator 20 has a housing 28. Both the first modulator unit 27 and the second modulator unit 57 are arranged in the housing 28. The pressurized-gas output 22, the further pressurized-gas output 52, the pressurized-gas input 21, the further pressurized-gas input 51, the vent opening 23, the further vent opening 53 and the control-pressure input 24 are realized on the housing 28. The relay valve 30, the vent valve 40, the further relay valve 30′ and the further relay valve 40′ are each actuated in dependence on the control pressure 24. Optionally, actuation of the vent valve 40 is effected in dependence on a pressure differential or quotient between the pressure at the pressurized-gas output 22 and the control pressure P_{cc}, and actuation of the vent valve 40′ is effected in dependence on a pressure differential or quotient between the pressure at the further pressurized-gas output 52 and the control pressure P_{cc}.

The modulator 20 may be designed in such a way that the first modulator unit 27 and the second modulator unit 57 are structurally identical and/or mirror images of each other. This makes it possible to use the same components for both modulator units.

While FIG. 5 represents a design in which only a single pneumatic load 11 is fluidically connected to the first modulator unit 27, and in which only a single pneumatic load 50 is fluidically connected to the second modulator unit 57, a plurality of pneumatic loads may also be fluidically connected to one or both of the modulator units 27, 57. In this case, the pneumatic vehicle system 10 is advantageously designed in such a way that each pneumatic load coupled to the modulator 20 is fluidically connected to only exactly one relay valve and only exactly one vent valve.

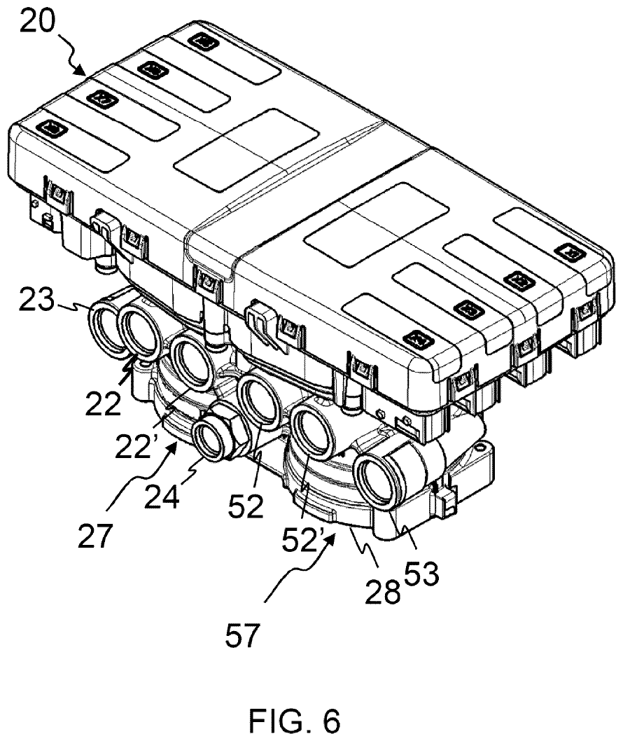

FIG. 6 shows a perspective view of a modulator 20 that comprises a first modulator unit 27 and a second modulator unit 57. The modulator 20 is configured in such a way that a plurality of pressurized-gas outputs 22, 22′ or 52, 52′ are connected to each of the modulator units 27, 57. The modulator 20 is configured to supply two pneumatic loads, which are connected to the pressurized-gas outputs 22, 22′, with pressurized gas via the relay valve 30 of the first modulator unit 27 and to vent them via the relay valve 30 of the first modulator unit 27 and the vent valve 40 of the first modulator unit 27.

The modulator 20 is configured to supply two additional pneumatic loads, which are connected to the pressurized-gas outputs 52, 52′, with pressurized gas via the further relay valve 30′ of the second modulator unit 57 and to vent them via the further relay valve 30′ of the second modulator unit 57 and the further vent valve 40′ of the second modulator unit 57.

In the case of the modulator 20 of FIG. 6, the modulator units 27, 57, vent valves 40, 40′ and relay valves 30, 30′ may be designed and configured with functional capability as explained with reference to FIG. 1 to FIG. 5. As explained with reference to FIG. 5, the housing 28 of the modulator 20 has a plurality of vent openings 23, 53 and a control-pressure input 24. In addition, the housing 28 has at least one pressurized-gas input.

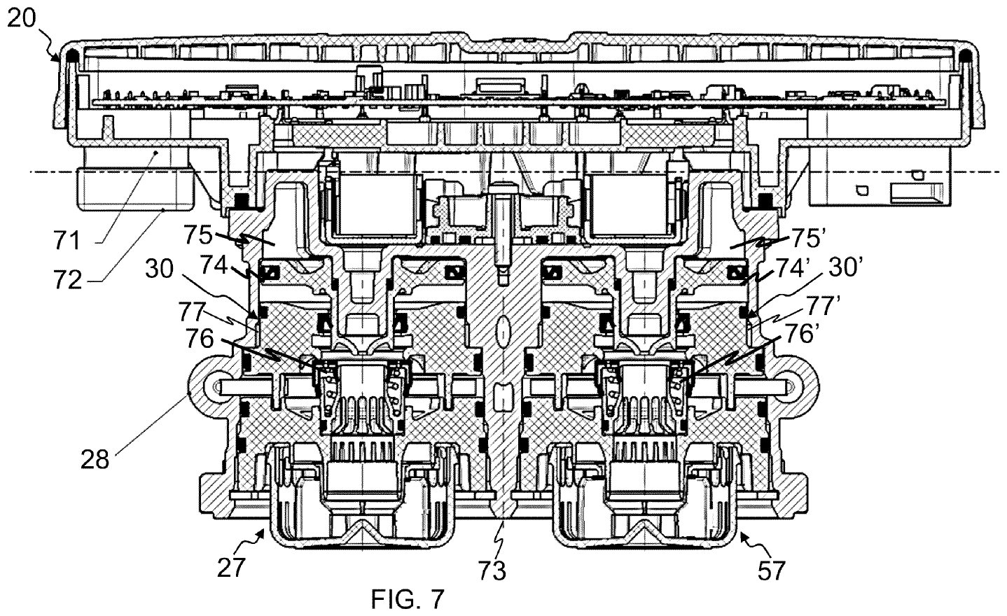

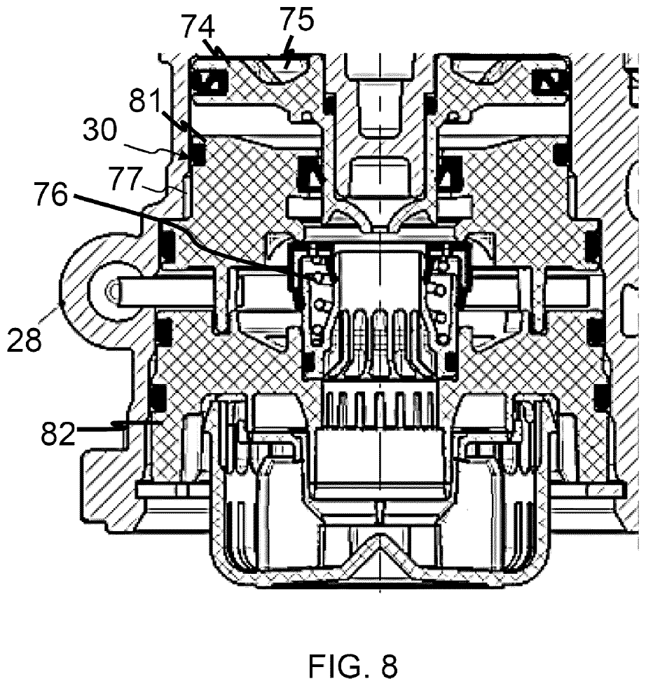

FIG. 7 shows a sectional view of the modulator 20 of FIG. 6. FIG. 8 shows a detail of the sectional view. Further design features that may be used to implement the relay valve 30 are described below with reference to FIG. 7 and FIG. 8.

The modulator 20 has an electronic control unit 71, represented in FIG. 7. A cover 72 may be provided on the electronic control unit 71.

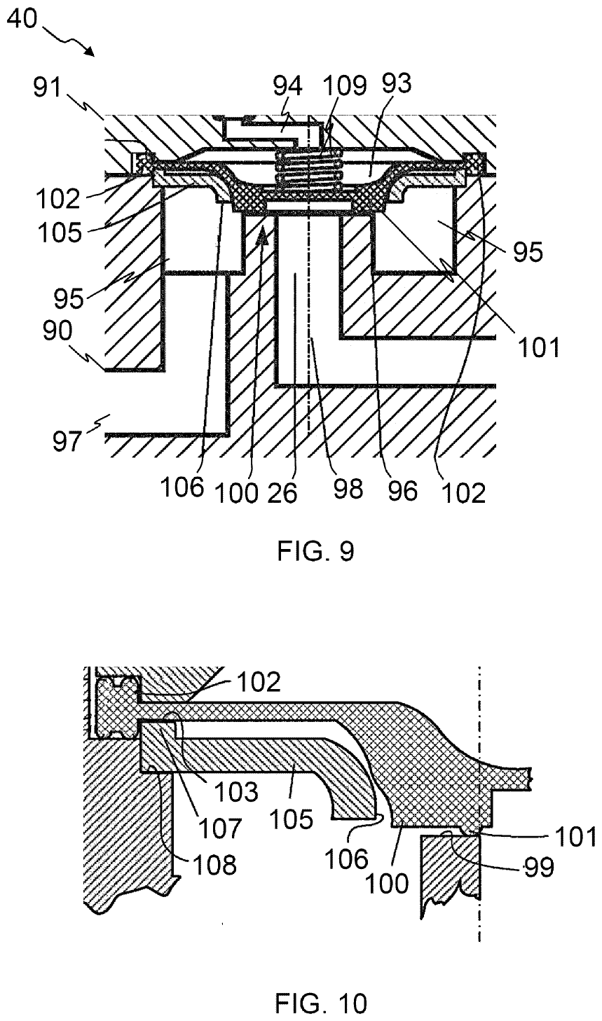

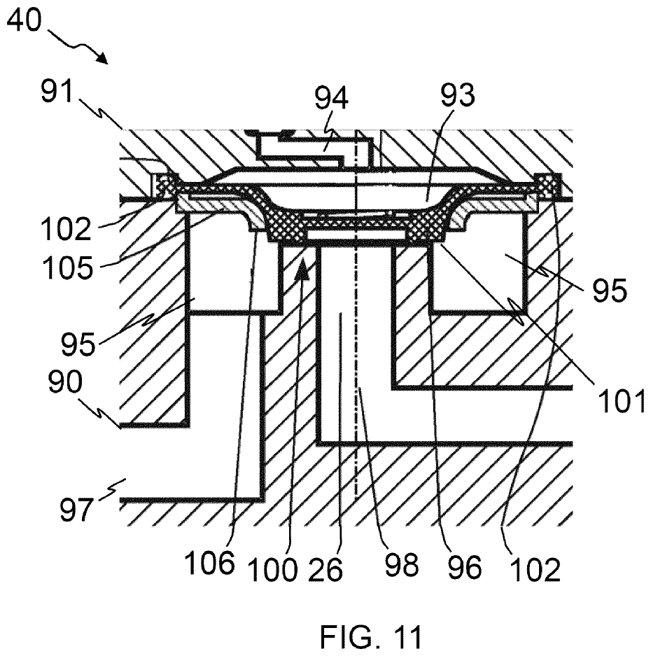

The first modulator unit 27, comprising the relay valve 30, is arranged in the housing 28 of the modulator 20. The vent valve 40 of the first modulator unit 27 is arranged offset with respect to the section plane of FIG. 7 and FIG. 8. Features of the vent valve 40 are therefore described in more detail below with reference to FIG. 9, FIG. 10 and FIG. 11. The relay valve 30 has a piston 74. The piston 74 is axially displaceable (i.e. in FIG. 7 in a direction parallel to a center plane 73 of the modulator 20) by a pneumatic control pressure. The piston 74 is thus movable relative to a first static relay-valve component 81 and a second static relay-valve component 82 in the housing 28. The modulator has a control-pressure chamber 75, which is fluidically connected to the control-pressure input 24. The piston 74 is moved in dependence on the control pressure at the control-pressure input 24. In this way, depending on the magnitude of the control pressure, a fluidic connection is provided between a pressure output chamber 77, which is fluidically connected to the pressurized-gas output 22, and either the pressurized-gas input 21 or the vent opening. When the piston 74 is in a first axial position, the pressure output chamber 77 is fluidically connected to the vent opening via the first venting path. When the piston 74 is in a second axial position, the pressure output chamber 77 is fluidically connected to the pressurized-gas output 22 via the relay valve 30. As best seen in the enlarged detail view of FIG. 8, the pressure output chamber 77 may extend in the form of a ring around a static relay-valve component 81.

The further relay valve 30′ of the second modulator unit 57 is of a design identical to that of the relay valve 30, the components being arranged in mirror-image relative to the center plane 73. To avoid repetition, therefore, a separate description of the components of the further relay valve 30′ is not provided. The design features explained above may accordingly also be realized in the case of the further relay valve 30′.

Each of the modulator units 27, 57 has a vent valve 40, 40′. The vent valve 40, 40′ in this case is designed such that it always provides venting of a pneumatic load via a second venting path, which is different from the first venting path, when a pressure difference or a quotient between the pressurized-gas output, to which the pneumatic load is connected, and the control pressure attains or exceeds a threshold value. The vent valve 40, 40′ is therefore designed to selectively provide venting via the second venting path when, upon a drop in the control pressure, the pressure in the working circuit (i.e. the pressure present at the pressurized-gas output) drops too slowly compared to the control pressure, such that the pressure difference between the pressure at the pressurized-gas output and the control pressure attains or exceeds the pressure threshold value.

FIG. 9 is a sectional view of a design variant of the vent valve 40. The further vent valve 40′, if present, may be designed in an identical manner.

The vent valve 40 may have connection channels and/or fluid spaces realized in at least one static modulator component 90, 91. In the case of the design represented, the modulator 20 has at least two static modulator components 90, 91, one of which bears flatly against the other. Other designs are possible in order to form the connection channels and/or fluid spaces.

The vent valve 40 is realized as a diaphragm valve and has a diaphragm 100. The control pressure (in a first fluid space 93) and a working pressure (in a second fluid space 95), i.e. a pressure in the working circuit, are applied to mutually opposite main faces of the diaphragm 100. The diaphragm 100 may be fastened, in particular clamped, between the static modulator components 90, 91.

The vent valve 40 has a connection channel 94 that fluidically connects the first fluid space 93 such that the first fluid space 93 fluidically communicates with the control-pressure input 24. The vent valve 40 has a further connection channel 97, which fluidically connects the second fluid space 95 such that the second fluid space 95 fluidically communicates with the pressurized-gas output 22. A wall region 96 of at least one of the static modulator components 90, 91 is arranged between the second fluid space 95 and the second venting path 26. The wall region 96 may have a cylindrical portion defining an outer wall of at least part of the second venting path 26 and an inner wall of at least part of the second fluid space 95.

The threshold value of the pressure difference or pressure quotient at which the vent valve 40 opens may be defined by the geometry of the diaphragm 100 (and in particular by a surface-area ratio of the free surface areas at the first fluid space 93, upon which the control pressure acts, and at the second fluid space 95, upon which the pressure at the pressurized-gas output acts) and the energy storage element 109. In the case of one design, for example, the surface-area ratio may be selected such that the control pressure acts upon the diaphragm 100 via a first diaphragm surface area that is at least 1.1 times, at least 1.2 times, at least 1.3 times or at least 1.4 times a second diaphragm surface area via which the working pressure (i.e. the pressure in the second fluid space 95) can act upon the diaphragm 100. The free surface areas may be defined, in particular, by use of the support element 105.

FIG. 10 shows an enlarged detail view of the diaphragm 100 and of the support element 105. The support element 105 is optional and may also be omitted. The diaphragm 100 has a peripheral edge 102. The peripheral 102 may have a thickened portion. The thickened portion may have a plurality of sealing features, for example a plurality of sealing beads, that surround the diaphragm at the peripheral edge 102.

The support element 105, if present, may have a fixed support-element end 107 that bears flatly between a diaphragm face 103 and one of the modulator components 91, 92. The fixed support-element end 107 may likewise have a thickened portion and may be held in a clamped manner. A support element face 108 may bear flatly against one of the modulator components 91, 92.

FIG. 11 shows a modification of the vent valve 40, the vent valve 40 being a springless diaphragm valve. Unlike the design explained with reference to FIG. 9 and FIG. 10, the energy storage element 109 is not present. The further design features correspond to the features explained with reference to FIG. 9 and FIG. 10. Due to the elastic return properties of the diaphragm 100 itself and/or the control pressure acting upon the diaphragm 100, it can be ensured that the sealing face 101 bears in a sealing manner against the valve seat 99, as long as the valve 40 is in the closed position.

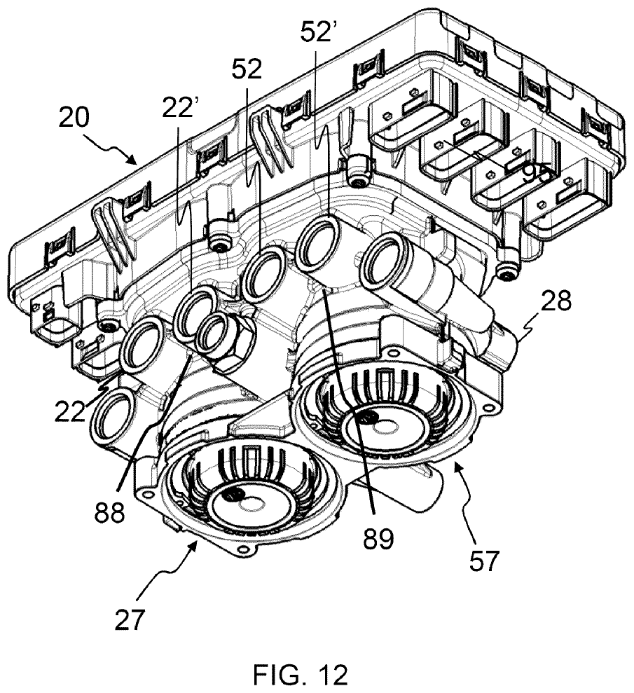

In the case of the modulators according to any of the embodiments disclosed herein, it may be advantageous for the vent valve or the vent valves to be arranged in proximity to the pressurized-gas outputs or the pressurized-gas output to which the vent valve or the vent valves are respectively fluidically connected. This is explained in more detail for the modulator in FIG. 6, FIG. 7 and FIG. 8, with reference to FIG. 12.

FIG. 12 shows a further perspective view of the modulator 20 of FIG. 6. The modulator 20 has a wall region 88 of the housing between the pressurized-gas outputs 22, 22′, which are fluidically connected to the vent valve 40 of the first modulator unit 27. It is advantageous for the vent valve of the first modulator unit 27 to be arranged in the housing 28 such that it is positioned in proximity to the pressurized-gas outputs 22, 22′. It may be particularly advantageous for the vent valve of the first modulator unit 27 to be arranged in the housing 28 such that it is located behind the wall region 88 that is arranged between the pressurized-gas outputs 22, 22′ or that is otherwise located adjacent to the pressurized-gas outputs 22, 22′. The modulator 20 has a further wall region 89 of the housing between the pressurized-gas outputs 52, 52′, which are fluidically connected to the further vent valve of the second modulator unit 57. It is advantageous for the further vent valve of the second modulator unit 57 to be arranged in the housing 28 such that it is positioned in proximity to the pressurized-gas outputs 52, 52′. It may be particularly advantageous for the further vent valve of the second modulator unit 57 to be arranged in the housing 28 such that it is located behind the further wall region 89 that is arranged between the pressurized-gas outputs 52, 52′ or that is otherwise located adjacent to the pressurized gas outputs 52, 52′.

Modulators according to embodiments may be used in various ways, in particular in various pneumatic vehicle systems and/or as various components of pneumatic vehicle systems. The modulator according to an embodiment may be designed as a modulator for supplying brake cylinders of a front axle or as a rear-axle modulator. Modulators according to embodiments may be used, in particular, in pneumatic braking systems of commercial vehicles, advantageously also in pneumatic braking systems that have an EBS.

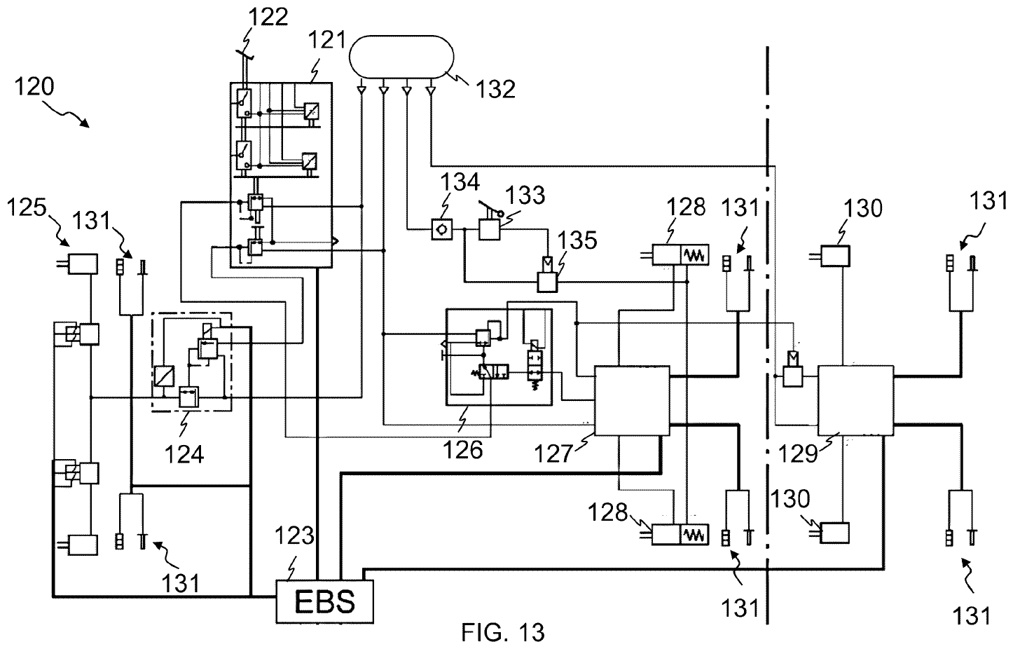

FIG. 13 shows a pneumatic vehicle system 120 designed as a braking system. The braking system has a braking-value transmitter 121. An actuating element 122, for example a pedal, may be arranged on the braking-value transmitter 121 or coupled to it. An EBS 123 may be coupled to the braking-value transmitter 121 in order to generate commands for the braking-value transmitter 121 and/or for the modulators 124, 127, 129 in dependence, for example, on sensor signals or sensor data sensed by way of sensors 131.

The braking system has a plurality of modulators 124, 127, 129, each of which is configured to convert a control pressure into a pressure in a working circuit. One or more or all of these modulators may be designed according to an embodiment. The modulator 124 may be configured and connected to increase a pressure in brake cylinders 125 of a front axle by connection to a source of pressurized gas, or reduce the pressure by venting. The modulator 124 may be designed as a modulator according to an embodiment. Alternatively or additionally, a modulator 127 may be provided that is designed as a rear-axle modulator and that is configured and connected to separately influence a pressure in brake cylinders 128 of a rear axle. Alternatively or additionally, a modulator 129 may be provided that is designed as a further rear-axle modulator and that is configured and connected to separately influence a pressure in further brake cylinders 130 of a further rear axle. One or more or all of the modulators 124, 127, 129 may be realized as modulators according to embodiments.

The braking system may comprise further components that are known per se. A pressurized gas reservoir 132 may be arranged and connected to provide pressurized gas or pneumatic pressure to the pressurized-gas inputs of the modulators 124, 127, 129. Various pneumatic components, such as control valves 133,135 or one or more check valves 134, may be arranged in the braking system.

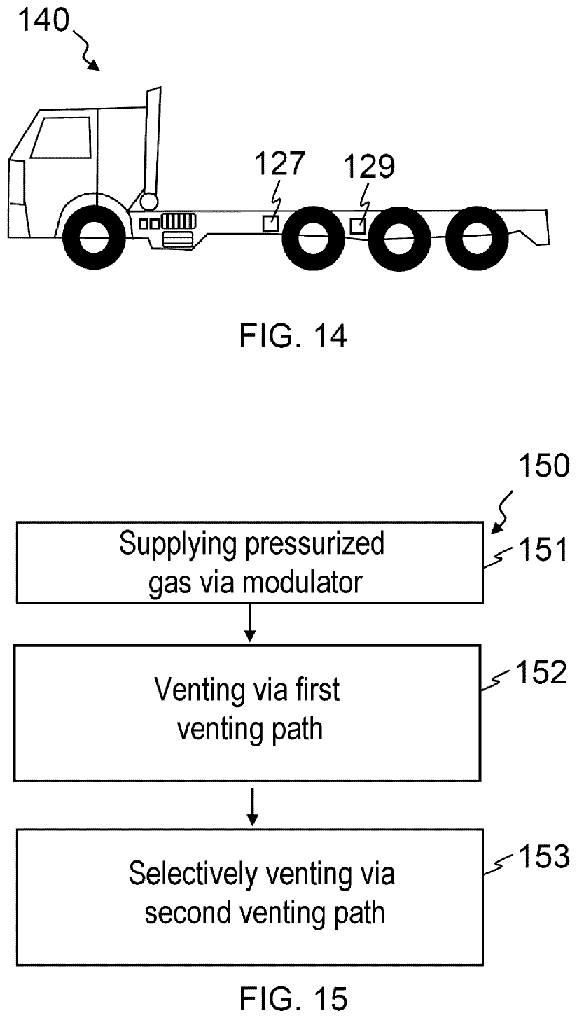

FIG. 14 shows a schematic representation of a commercial vehicle 140. The commercial vehicle 140 has one or more modulators, at least one of which is designed as a modulator according to an embodiment. For example, the commercial vehicle 140 may have one or more axle modulators 127, 129, designed as a modulator according to an embodiment. The commercial vehicle 140 may comprise the braking system of FIG. 13.

FIG. 15 is a flow diagram of a method 150 according to an embodiment. The method 150 may be executed by or by way of the modulator according to an embodiment, the pneumatic vehicle system according to an embodiment, or the commercial vehicle according to an embodiment.

In step 151, pressurized gas is supplied to a pneumatic load via the modulator. For this purpose, a pressurized-gas output, which is fluidically connected to the pneumatic load, is connected to a pressurized-gas input of the modulator via a relay valve. The pressurized-gas input of the modulator is fluidically connected to a pressurized-gas source, which may also be designed as a pressurized-gas reservoir.

In step 152, the pneumatic load is vented via the modulator. For this purpose, a fluidic connection is established between the pressurized-gas output and a first venting path of the modulator, via the relay valve.

In step 153, the pneumatic load is additionally vented via a second venting path of the modulator in parallel to venting via the first venting path. For this purpose, a fluidic connection is established between the pressurized-gas output and the second venting path of the modulator, via a vent valve that is different from the relay valve. The connection to the second venting path may be established selectively in dependence on how closely the pressure follows the control pressure when a control pressure received by the modulator drops.

Further optional features of the method and the effects respectively achieved thereby correspond to the features and effects explained with reference to the modulator, the pneumatic vehicle system and the commercial vehicle.

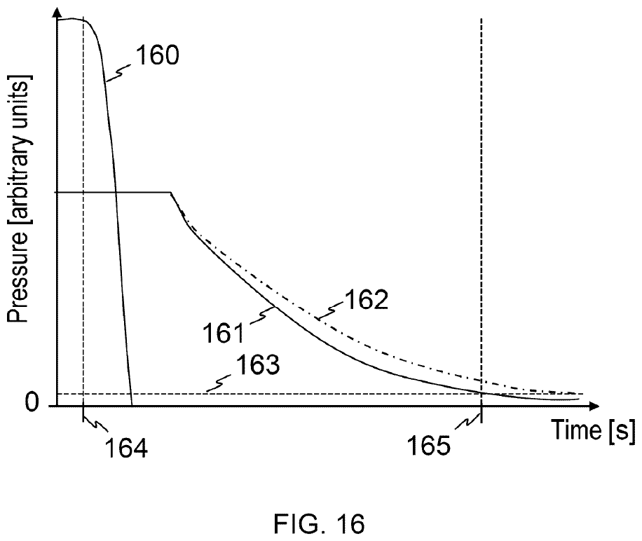

FIG. 16 shows pressure curves to further explain the function of the modulator, the pneumatic vehicle system, the commercial vehicle and the method according to embodiments. The pressure curves are represented as a function of time. Represented is a brake pressure 160 that drops, beginning at a start time 164. FIG. 16 shows a pressure curve 161 that represents a drop in pressure at the pressurized-gas output in the case of a modulator according to an embodiment. Additionally represented, for comparison, is a pressure curve 162, which represents a drop in the pressure at the pressurized-gas output in the case of a conventional modulator that has neither the vent valve nor the second venting path. The pressure curve 161 attains a target value 163 within a pressure-drop time 165, calculated from the start time 164. By comparison, the pressure-drop time in which the target value 163 is attained is longer in the case of the conventional pressure curve 162.

The modulator, the pneumatic vehicle system, the commercial vehicle and the method according to exemplary embodiments thus enable the time in which a pressure in the working circuit drops in response to a drop in a pressure in the control circuit to be reduced.

Accordingly, also provided according to further embodiments of the present disclosure is the use of the modulator, the pneumatic vehicle system, the commercial vehicle and the method according to an embodiment for reducing the pressure-drop time, in which a pressure in the working circuit attains a target value.

Modulators, pneumatic vehicle systems, commercial vehicles and methods according to exemplary embodiments have been described with reference to the figures. Variations and modifications may be realized in further embodiments.

Examples of further variations of the embodiments disclosed in detail include, but are not limited to, the following variations: While the vent valve 40 may be designed as a diaphragm valve, other implementations of the vent valve 40 may be used. The vent valve 40 need not necessarily comprise an energy storage element 109 and/or a support element 105. The relay valve 30 may be implemented in any conventional manner. While the first venting path 25 and the second venting path 26 may lead into one same vent opening 23, in other designs the first venting path 25 and the second venting path 26 may lead into separate vent openings. The features of the disclosed exemplary embodiments may be combined with each other, unless this is expressly excluded.

The modulators, pneumatic vehicle systems, commercial vehicles and methods according to embodiments may be used, in particular, for commercial vehicles that have a longer wheelbase, without being limited thereto. The modulators, pneumatic vehicle systems, commercial vehicles and methods according to embodiments may be used in a particularly advantageous manner in order to reduce a time delay in the dropping of a brake pressure at the brake cylinder or brake cylinders in response to a reduction of the control pressure, without being limited to this application.

### LIST OF REFERENCE DESIGNATIONS (PART OF THE DESCRIPTION)

10 pneumatic vehicle system
11, 11′ pneumatic load
12 connection line
13 pressurized-gas source
14 further connection line
20 modulator
21 pressurized-gas input
22 pressurized-gas output
22 second pressurized-gas output
23 vent opening
24 control-pressure input
25 first venting path
26 second venting path
27 first modulator unit
28 housing
30 relay valve
30 further relay valve
31 first relay-valve valve port
32 second relay-valve valve port
33 third relay-valve valve port
34 relay-valve control port
40 vent valve
40′ further vent valve
42 first vent-valve valve port
43 second vent-valve valve port
44 vent-valve control port
44.1 further vent-valve control port
50 further pneumatic load
51 further pressurized-gas input
52 further pressurized-gas output
52 further second pressurized-gas output
53 further vent opening
54 connection line
57 second modulator unit
71 electronic control unit
72 protective cover
73 center plane
74 piston
74′ further piston
75 control-pressure chamber
75′ further control-pressure chamber
76 helical spring
76′ further helical spring
77 pressure output chamber
77′ further pressure output chamber
81 first static relay-valve component
82 second static relay-valve component
88 modulator wall region
89 further modulator wall region
90 static modulator component
91 further static modulator component
93 first fluid space
94 connection channel
95 second fluid space
96 wall region
97 further connection channel
98 axis
99 valve seat
100 diaphragm
101 sealing face
102 peripheral edge
103 diaphragm face
105 support element
106 free support-element end
107 fixed support-element end
108 support-element face
109 energy storage element
120 pneumatic vehicle system
121 braking-value transmitter
122 actuating element
123 electronic braking system
124 modulator
125 front-axle brake cylinder
126 redundancy valve
127 axle modulator
128 brake cylinder
129 further axle modulator
130 brake cylinder
131 sensors
132 pressurized-gas reservoir
133 control valve
134 check valve
135 further control valve
140 commercial vehicle
150 method
151 method step
152 method step
153 method step
160 control pressure
161 output-pressure curve
162 comparison output-pressure curve
163 pressure threshold value
164 start time
165 pressure-drop time
P_{cc} control pressure

What is claimed is:

1. A modulator (20; 124, 127, 129) for generating a pressure change, the modulator comprising:
a control-pressure input (24) for receiving a control pressure (P_{cc}),
a pressurized-gas input (21; 51),
at least one pressurized-gas output (22; 22, 22′; 22, 52; 22, 22′, 52, 52′),
a first venting path (25) and a second venting path (26) for venting a pneumatic load (11; 11, 11′; 11, 50; 125, 128, 130), at least part of the first venting path (25) being different from at least part of the second venting path (26),
a relay valve (30; 30′) that is pneumatically controllable by the control pressure (P_{cc}) and has at least a first valve position and a second valve position, the relay valve (30; 30′) being configured to provide, in the first valve position, a fluidic connection between the pressurized-gas input (21; 51) and the at least one pressurized-gas output (22; 22, 22′; 22, 52; 22, 22′, 52, 52′) and to provide, in the second valve position, a fluidic connection between the at least one pressurized-gas output (22; 22, 22′; 22, 52; 22, 22′, 52, 52′) and the first venting path (25) for the purpose of venting the pneumatic load (11; 11, 11′; 11, 50; 125, 128, 130), and
a vent valve (40; 40′) that is pneumatically controllable by the control pressure (P_{cc}) and that is configured to selectively provide, in dependence on the control pressure (P_{cc}), a fluidic connection between the at least one pressurized-gas output (22; 22, 22′; 22, 52; 22, 22′, 52, 52′) and the second venting path (26) for the purpose of venting the pneumatic load (11; 11, 11′; 11, 50; 125, 128, 130).

2. The modulator (20; 124, 127, 129) as claimed in claim 1, wherein the relay valve (30; 30′) and the vent valve (40; 40′) vent the pneumatic load (11; 11, 11′; 11, 50; 125, 128, 130) in parallel via the first venting path (25) and the second venting path (26).

3. The modulator (20; 124, 127, 129) as claimed in claim 1, wherein the vent valve (40; 40′) provides the fluidic connection between the at least one pressurized-gas output (22; 22, 22′; 22, 52; 22, 22′, 52, 52′) and the second venting path (26) upon a decrease in the control pressure (P_{cc}).

4. The modulator (20; 124, 127, 129) as claimed in claim 3, wherein the vent valve (40; 40′) provides the fluidic connection between the at least one pressurized-gas output (22; 22, 22′; 22, 52; 22, 22′, 52, 52′) and the second venting path (26) in dependence on a rate at which the control pressure (P_{cc}) decreases.

5. The modulator (20; 124, 127, 129) as claimed in claim 3, wherein the vent valve (40; 40′) provides the fluidic connection between the at least one pressurized-gas output (22; 22, 22′; 22, 52; 22, 22′, 52, 52′) and the second venting path (26) in dependence on a ratio between the control pressure (P_{cc}) and a pressure at the at least one pressurized-gas output (22; 22, 22′; 22, 52; 22, 22′, 52, 52′).

6. The modulator (20; 124, 127, 129) as claimed in claim 1, wherein the vent valve includes a diaphragm (100).

7. The modulator (20; 124, 127, 129) as claimed in claim 6, wherein the modulator (20; 124, 127, 129) includes a control-pressure chamber (82) that is fluidically connected to the control-pressure input (21; 51),
Wherein at least one region of the diaphragm (100) is arranged between a first fluid space (93) and a second fluid space (95),
Wherein the first fluid space (93) is fluidically connected to the control-pressure chamber, and/or the second fluid space (95) is fluidically connected to the at least one pressurized-gas output (22; 22, 22′; 22, 52; 22, 22′, 52, 52′).

8. The modulator (20; 124, 127, 129) as claimed in claim 7, wherein the vent valve (40; 40′) further includes a reversibly deformable energy storage element (109), wherein the diaphragm (100) includes a side on which both the reversibly deformable energy storage element (109) and the first fluid space (93) are arranged.

9. The modulator (20; 124, 127, 129) as claimed in claim 6, wherein the vent valve (40) is configured for bearing of the diaphragm (100) in a sealing manner against a valve seat (99) under the action of the control pressure (P_{cc}) upon the diaphragm (100).

10. The modulator (20; 124, 127, 129) as claimed in claim 6, the vent valve (40; 40′) further comprising a support element (105) that extends along part of the diaphragm (100).

11. The modulator (20; 124, 127, 129) as claimed in claim 6, wherein the diaphragm (100) includes a peripheral edge (102) and a sealing face (101) that is spaced apart from the peripheral edge (102), wherein the sealing face (101) is configured for bearing in a sealing manner against a valve seat (99).

12. The modulator (20; 124, 127, 129) as claimed in claim 5, wherein the vent valve includes a diaphragm (100), wherein the vent valve (40; 40′) provides the fluidic connection between the at least one pressurized-gas output (22; 22, 22′; 22, 52; 22, 22′, 52, 52′) and the second venting path (26) if the ratio attains a threshold value that is dependent on a geometric design of the diaphragm (100).

13. The modulator (20; 124, 127, 129) as claimed in claim 1, wherein the vent valve (40; 40′) and the relay valve (30; 30′) are configured such that, upon a drop in the control pressure (P_{cc}), the vent valve (30; 30′) provides the fluidic connection between the pressurized-gas output (22; 22, 22′; 22, 52; 22, 22′, 52, 52′) and the second venting path (26) after the relay valve (30; 30′) provides the fluidic connection between the pressurized-gas output (22; 22, 22′; 22, 52; 22, 22′, 52, 52′) and the first venting path (25).

14. The modulator (20; 124, 127, 129) as claimed in claim 1, wherein the modulator (20; 124, 127, 129) further includes a housing (28), wherein the modulator (20; 124, 127, 129) further includes a vent opening (23) in the housing (28), wherein both the first venting path (25) and the second venting path (26) lead into the vent opening (23).

15. A pneumatic vehicle system (120), comprising
at least one pneumatic load (11; 11, 11′; 11, 50; 125, 128, 130),
the modulator (20; 124, 127, 129) as claimed in claim 1, and
at least one connection (12; 54) that fluidically connects the at least one pneumatic load (11; 11, 11′; 11, 50; 125, 128, 130) to the modulator (20; 124, 127, 129).

16. The pneumatic vehicle system (120) as claimed in claim 15, wherein the at least one pneumatic load (11; 11, 11′; 11, 50; 125, 128, 130) comprises one brake cylinder (11; 11, 11′; 11; 50; 125, 128, 130) or a plurality of brake cylinders (125, 128, 130).

17. A commercial vehicle (140), comprising the modulator (20; 124, 127, 129) as claimed in claim 1.

18. A commercial vehicle (140), comprising the pneumatic vehicle system (120) as claimed in claim 15.

19. A method for controlling a pneumatic pressure in a pneumatic load (11; 11, 11′; 11, 50; 125, 128, 130) by open-loop or closed-loop control by use of a modulator (20; 124, 127, 129), the modulator (20; 124, 127, 129) having a first venting path (25) and a second venting path (26), at least part of the first venting path (25) being different from at least part of the second venting path (26), the method comprising:
supplying pressurized gas from a pressurized-gas source (13) to the pneumatic load (11; 11, 11′; 11, 50; 125, 128, 130) via the modulator (20; 124, 127, 129), and
venting the pneumatic load (11; 11, 11′; 11, 50; 125, 128, 130) via the modulator (20; 124, 127, 129), comprising:
pneumatically actuating a relay valve (30; 30′) of the modulators (20; 124, 127, 129) by way of a control pressure (P_{cc}) received by the modulator (20; 124, 127, 129) in order to vent the pneumatic load (11; 11, 11′; 11, 50; 125, 128, 130) via the first venting path (25), and
pneumatically actuating a vent valve (40; 40′) by way of the control pressure (P_{cc}) in order to additionally vent the pneumatic load (11; 11, 11′; 11, 50; 125, 128, 130) via the second venting path (26).
